(19) United States
(12) Patent Application Publication
(10) Pub. No.: US 2025/0392414 A1
(43) Pub. Date: Dec. 25, 2025

(54) COMMUNICATION APPARATUS, COMMUNICATION METHOD, AND COMMUNICATION SYSTEM

(71) Applicant: NEC Corporation, Tokyo (JP)

(72) Inventor: Yohei HASEGAWA, Tokyo (JP)

(73) Assignee: NEC Corporation, Tokyo (JP)

(21) Appl. No.: 19/232,979

(22) Filed: Jun. 10, 2025

(30) Foreign Application Priority Data
Jun. 20, 2024 (JP) 2024-099846

(51) Int. Cl. H04L 1/1829; H04B 10/11

(52) U.S. Cl. CPC H04L 1/1858; H04B 10/11

(57) ABSTRACT

A communication apparatus includes a receiving unit that receives, from the communication apparatus on the other side, an acknowledgement including at least one of a decoded-data number corresponding to successfully-decoded data, and a received-data number corresponding to data included in the successfully received first and second packets, and a control unit that controls retransmission of the first and second packets based on at least one of the decoded-data number and the received-data number.

### INCORPORATION BY REFERENCE

This application is based upon and claims the benefit of priority from Japanese patent application No. 2024-099846, filed on Jun. 20, 2024, the disclosure of which is incorporated herein in its entirety by reference.

### TECHNICAL FIELD

The present disclosure relates to a communication apparatus, a communication method, and a communication system.

### BACKGROUND ART

Recently, optical free space communication in which light is used as a transmission medium has been attracting attention. Optical free space communication is easily affected by external disturbances, and situations such as deterioration of communication quality occur due to external disturbances. Examples of technologies related to this include an invention disclosed in Patent Literature 1 mentioned below.

Patent Literature 1 discloses that a first mobile unit can perform, in a case where there is no response from a second mobile unit or even in a protocol according to which no response is originally transmitted, retransmission to the second mobile unit as required.

Patent Literature 1: Japanese Unexamined Patent Application Publication No. 2012-186662

### SUMMARY

In optical free space communication, there is a possibility that a continuous burst error (momentary interruption) exceeding 1 ms occurs due to atmospheric fluctuations. To cope with such a burst error, there is a method in which data is encoded over a long time in a dispersed manner. However, this method increases the delay until the decoding is completed. It is necessary to shorten the delay until the decoding is completed while improving characteristics against burst errors.

Further, in the case where a packet coding method in which redundant codes are combined is used, it is necessary to improve the efficiency of coding in the case where the transmission speed changes or where the transmission of some of packets is confirmed. Even if the technology disclosed in Patent Literature 1 is used, such problems cannot be solved.

The present disclosure has been made in view of the above-described problems, and an example object thereof is to provide a technology capable of efficiently performing the retransmission of packets even in the case where a packet coding method in which redundant codes are combined is used.

A communication apparatus according to an example aspect of the present disclosure includes: encoding means for generating encoded data encoded by using at least two data among a plurality of data; transmitting means for redundantly transmitting a first packet including at least one of the plurality of data and a second packet including the encoded data to a communication apparatus on the other side; receiving means for receiving, from the communication apparatus on the other side, an acknowledgement including at least one of a decoded-data number corresponding to data successfully decoded by using the first and second packets, and a received-data number corresponding to data included in the successfully received first and second packets; and control means for controlling retransmission of the first and second packets based on at least one of the decoded-data number and the received-data number.

A communication method according to an example aspect of the present disclosure includes: generating encoded data encoded by using at least two data among a plurality of data; redundantly transmitting a first packet including at least one of the plurality of data and a second packet including the encoded data to a communication apparatus on the other side; receiving, from the communication apparatus on the other side, an acknowledgement including at least one of a decoded-data number corresponding to data successfully decoded by using the first and second packets, and a received-data number corresponding to data included in the successfully received first and second packets; and controlling retransmission of the first and second packets based on at least one of the decoded-data number and the received-data number.

A communication system according to an example aspect of the present disclosure includes a first communication apparatus and a second communication apparatus, in which the first communication apparatus includes: encoding means for generating encoded data encoded by using at least two data among a plurality of data; first transmitting means for redundantly transmitting a first packet including at least one of the plurality of data and a second packet including the encoded data to the second communication apparatus; and first receiving means for receiving an acknowledgement from the second communication apparatus, the second communication apparatus includes: second receiving means for receiving the first and second packets from the first communication apparatus; decoding means for decoding data by using the first and second packets; and second transmitting means for transmitting, to the first communication apparatus, the acknowledgement including at least one of a decoded-data number corresponding to data successfully decoded by using the first and second packets, and a received-data number corresponding to data included in the successfully received first and second packets, and the first communication apparatus further includes control means for controlling retransmission of the first and second packets based on at least one of the decoded-data number and the received-data number included in the acknowledgement received by the first receiving means.

According to an example aspect of the present disclosure, it is possible to provide an example effect that the retransmission of packets can be efficiently performed even in the case where a packet coding method in which redundant codes are combined is used.

### BRIEF DESCRIPTION OF DRAWINGS

The above and other aspects, advantages and features will be more apparent from the following description of certain example embodiments taken in conjunction with the accompanying drawings, in which:

FIG. 1 is a block diagram showing an example of a configuration of a communication apparatus according to the present disclosure;

FIG. 2 is a flowchart for explaining a processing procedure of a communication apparatus according to the present disclosure;

FIG. 3 is a block diagram showing an example of a configuration of a communication system according to the present disclosure;

FIG. 4 is a block diagram showing an example of a configuration of a communication apparatus according to the present disclosure;

FIG. 5 shows an example of a transmitting buffer of a communication apparatus according to the present disclosure;

FIG. 6 shows an example of a receiving buffer of a communication apparatus according to the present disclosure;

FIG. 7 shows an example of an encoding method of a communication apparatus according to the present disclosure;

FIG. 8 shows an example of a packet retransmission method of a communication apparatus according to the present disclosure;

FIG. 9 shows an example of a packet retransmission method in a case where degree of redundancy is specified;

FIG. 10 shows an example of a packet retransmission method in a case where a delay constraint is specified; and

FIG. 11 is a block diagram showing a configuration of a computer which functions as a communication apparatus according to the present disclosure.

### EXAMPLE EMBODIMENT

An example embodiment according to the present disclosure is shown hereinafter. However, the present disclosure is not limited to example embodiments shown below, and various modifications can be made within the scope of the claims. For example, example embodiments obtained by combining technical means employed in example embodiments shown below may also be included in the scope of the present disclosure. Further, example embodiments obtained by removing some of technical means employed in the example embodiments shown below may also be included in the scope of the present disclosure. Further, effects mentioned in example embodiments shown below are merely examples of effects expected in the example embodiments shown below, and do not define the extension of the present disclosure. That is, example embodiments which do not provide effects mentioned in example embodiments shown below may also be included in the scope of the present disclosure.

### First Example Embodiment

A first example embodiment, which is an example of an example embodiment according to the present disclosure, will be described in detail with reference to the drawings. This example embodiment is an example embodiment on which example embodiments described later are based. Note that the scope of the application of each technical means employed in this example embodiment is not limited to that in this example embodiment. That is, each technical means employed in this example embodiment can also be employed in other example embodiments included in the present disclosure to the extent that no particular technical difficulty occurs. Further, each technical means shown in the drawings that is referred to in order to explain this example embodiment can also be employed in other example embodiments included in the present disclosure to the extent that no particular technical difficulty occurs.

### Configuration of Communication Apparatus 1

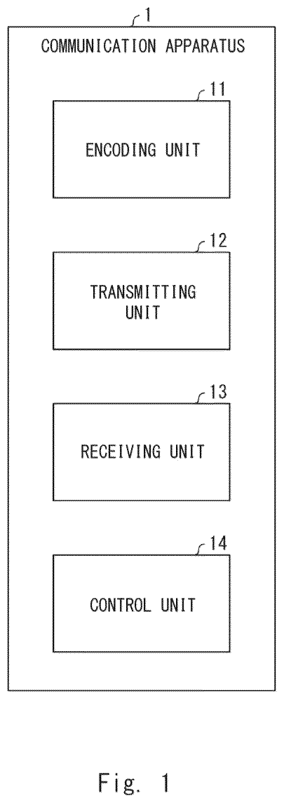

A configuration of a communication apparatus 1 will be described with reference to FIG. 1. FIG. 1 is a block diagram showing an example of the configuration of the communication apparatus 1. The communication apparatus 1 is applicable to an apparatus that performs optical free space communication, and is also applicable to, for example, an apparatus that uses radio waves. As shown in FIG. 1, the communication apparatus 1 includes an encoding unit 11, a transmitting unit 12, a receiving unit 13, and a control unit 14.

The encoding unit 11 generates encoded data encoded by using at least two data among a plurality of data. For example, in a case where data D0 to D3 are transmitted to a communication apparatus on the other side (i.e., a communication apparatus with which the communication apparatus 1 communicates), the encoding unit 11 generates encoded data by calculating exclusive OR between the data D0 and D1. Alternatively, the encoding unit 11 may generate encoded data by calculating exclusive OR among data D0, D1 and D2.

Any combination of data can be used as data to be encoded. Further, the number of data that the encoding unit 11 encodes is not limited to any particular numbers. Further, a case where exclusive OR is used as an example of a data encoding method will be described, but the encoding method is not limited to this example.

The transmitting unit 12 redundantly transmits a first packet including at least one of a plurality of data and a second packet including encoded data to the communication apparatus on the other side. For example, in a case where data D0 to D3 are transmitted to the communication apparatus on the other side, the transmitting unit 12 transmits a packet including at least one of data D0 to D3 to the communication apparatus on the other side as the first packet. Further, the transmitting unit 12 transmits a packet including encoded data encoded by the encoding unit 11 to the communication apparatus on the other side as the second packet.

Note that the redundant transmission refers to the transmission of the same data performed by a plurality of times, and refers to, for example, a case where a first packet including data D0 is transmitted and then a second packet including encoded data obtained by calculating exclusive OR between data D0 and D1 is transmitted.

The receiving unit 13 receives an acknowledgement from the communication apparatus on the other side. The acknowledgement includes at least one of a decoded-data number corresponding to data successfully decoded by using the first and second packets, and a received-data number corresponding to data included in the successfully received first and second packets.

Assume that the communication apparatus on the other side has received a first packet including data D0 from the communication apparatus 1, and then received a second packet including encoded data obtained by calculating exclusive OR between data D0 and D1. In this case, the communication apparatus on the other side can decode the data D1 by calculating exclusive OR between the data D0 and the encoded data included in the second packet. The communication apparatus on the other side transmits, as decoded-data numbers, an acknowledgement including a number corresponding to the data D0 and an acknowledgement including a number corresponding to the data D1 to the communication apparatus 1.

Further, assume that the communication apparatus on the other side has successfully received the first packet including the data D0 from the communication apparatus 1, and then has successfully received the second packet including the encoded data obtained by calculating exclusive OR between the data D0 and D1 therefrom. In this case, the communication apparatus on the other side may transmit, as received-data numbers, an acknowledgement including a number corresponding to the data D0 and an acknowledgement including a number corresponding to the data D1 to the communication apparatus 1.

The control unit 14 controls the retransmission of the first and second packets based on at least one of the decoded-data number and the received-data number. For example, in a case where the control unit 14 receives, as decoded-data numbers, an acknowledgement including a number corresponding to the data D0 and an acknowledgement including a number corresponding to the data D1, it cancels the retransmission of the first or second packet including the data D0 or D1. Further, the control unit 14 may perform similar processes by referring to the received-data numbers.

### Effect of Communication Apparatus 1

As described above, in the communication apparatus 1, the control unit 14 controls the retransmission of the first and second packets based on at least one of the decoded-data number and the received-data number. Therefore, for example, it is possible to efficiently perform the retransmission of packets by canceling the retransmission of successfully decoded data and/or successfully received data.

### Flow of Communication Method

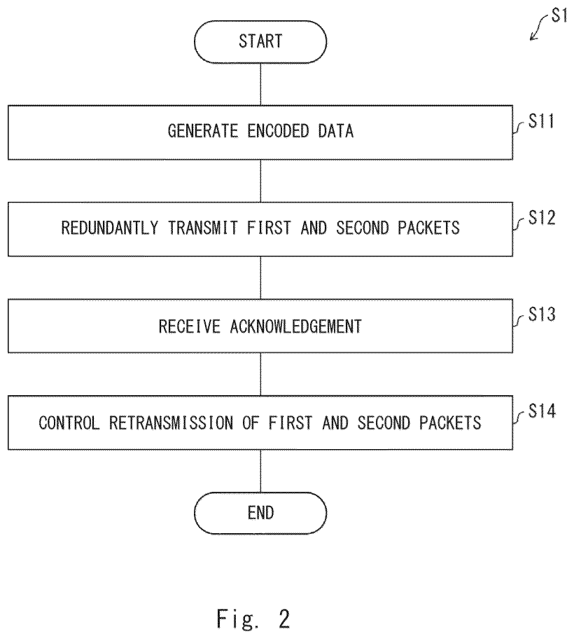

A flow of a communication method S1 will be described with reference to FIG. 2. FIG. 2 is a flowchart showing the flow of the communication method S1. As shown in FIG. 2, the communication method S1 includes processes S11 to S14.

Firstly, the encoding unit 11 generates encoded data encoded by using at least two data among a plurality of data (S11). For example, in a case where data D0 to D3 are transmitted to the communication apparatus on the other side, the encoding unit 11 generates encoded data by calculating exclusive OR between data D0 and D1. Alternatively, the encoding unit 11 may generate encoded data by calculating exclusive OR among data D0, D1 and D2.

Next, the transmitting unit 12 redundantly transmits a first packet including at least one of a plurality of data and a second packet including encoded data to the communication apparatus on the other side (S12). For example, in a case where data D0 to D3 are transmitted to the communication apparatus on the other side, the transmitting unit 12 transmits a packet including at least one of data D0 to D3 to the communication apparatus on the other side as the first packet. Further, the transmitting unit 12 transmits a packet including encoded data encoded by the encoding unit 11 to the communication apparatus on the other side as the second packet.

Next, the receiving unit 13 receives, from the communication apparatus on the other side, an acknowledgement including at least one of a decoded-data number corresponding to data successfully decoded by using the first and second packets, and a received-data number corresponding to data included in the successfully received first and second packets (S13).

Lastly, the control unit 14 controls the retransmission of the first and second packets based on at least one of the decoded-data number and the received-data number (S14). For example, in a case where the control unit 14 receives, as decoded-data numbers, an acknowledgement including a number corresponding to the data D0 and an acknowledgement including a number corresponding to the data D1, it cancels the retransmission of the first or second packet including the data D0 or D1.

### Effect of Communication Method

As described above, in the communication method S1, the control unit 14 controls the retransmission of the first and second packets based on at least one of the decoded-data number and the received-data number. Therefore, for example, it is possible to efficiently perform the retransmission of packets by canceling the retransmission of successfully decoded data and/or successfully received data.

### Configuration of Communication System 100

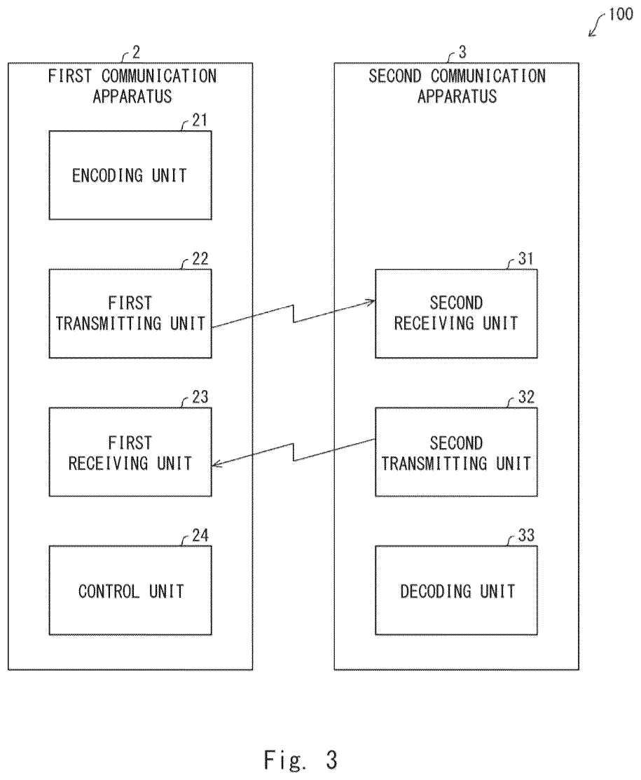

A configuration of a communication system 100 will be described with reference to FIG. 3. FIG. 3 is a block diagram showing an example of the configuration of the communication system 100. The communication system 100 is applicable to an apparatus that performs optical free space communication, and is also applicable to, for example, an apparatus that uses radio waves. As shown in FIG. 3, the communication system 100 includes a first communication apparatus 2 and a second communication apparatus 3.

The first communication apparatus 2 includes an encoding unit 21, a first transmitting unit 22, a first receiving unit 23, and a control unit 24. Further, the second communication apparatus 3 includes a second receiving unit 31, a second transmitting unit 32, and a decoding unit 33.

The encoding unit 21 of the first communication apparatus 2 generates encoded data encoded by using at least two data among a plurality of data. For example, in a case where data D0 to D3 are transmitted to the second communication apparatus 3, the encoding unit 21 generates encoded data by calculating exclusive OR between the data D0 and D1. Alternatively, the encoding unit 21 may generate encoded data by calculating exclusive OR among data D0, D1 and D2.

The first transmitting unit 22 of the first communication apparatus 2 redundantly transmits a first packet including at least one of the plurality of data and a second packet including the encoded data to the second communication apparatus 3. Further, the first receiving unit 23 of the first communication apparatus 2 receives an acknowledgement from the second communication apparatus 3. For example, in a case where data D0 to D3 are transmitted to the second communication apparatus 3, the first transmitting unit 22 transmits a packet including at least one of data D0 to D3 to the second communication apparatus 3 as the first packet. Further, the first transmitting unit 22 transmits a packet including encoded data encoded by the encoding unit 21 to the second communication apparatus 3 as the second packet.

The second receiving unit 31 of the second communication apparatus 3 receives the first and second packets from the first communication apparatus 2. For example, the second receiving unit 31 receives the first packet including the data D0 from the first communication apparatus 2, and then receives the second packet including the encoded data obtained by calculating exclusive OR between the data D0 and D1 therefrom.

The decoding unit 33 of the second communication apparatus 3 decodes data by using the first and second packets. For example, the decoding unit 33 can decode the data D1 by calculating exclusive OR between data D0 included in the first packet and the encoded data included in the second packet.

The second transmitting unit 32 of the second communication apparatus 3 transmits, to the first communication apparatus 2, an acknowledgement including at least one of a decoded-data number corresponding to data successfully decoded by using the first and second packets and a received-data number corresponding to data included in the successfully received first and second packets.

For example, the second transmitting unit 32 transmits, to the first communication apparatus 2, an acknowledgement including a number corresponding to the data D0 and an acknowledgement including a number corresponding to the data D1 as decoded-data numbers.

Further, assume that the second receiving unit 31 has successfully received the first packet including the data D0 from the first communication apparatus 2, and then has successfully received the second packet including the encoded data obtained by calculating exclusive OR between the data D0 and D1 therefrom. In this case, the second transmitting unit 32 may transmit, to the first communication apparatus 2, an acknowledgement including a number corresponding to the data D0 and an acknowledgement including a number corresponding to the data D1 as received-data numbers.

The control unit 24 of the first communication apparatus 2 controls the retransmission of the first and second packets based on at least one of the decoded-data number and the received-data number included in the acknowledgements received by the first receiving unit 23. For example, in a case where the control unit 24 receives an acknowledgement including a number corresponding to the data D0 and an acknowledgement including a number corresponding to the data D1 as decoded-data numbers, it cancels the retransmission of the first or second packet including the data D0 or D1. Further, the control unit 24 may perform similar processes by referring to the received-data numbers.

### Effect of Communication System 100

As described above, in the communication system 100, the control unit 24 of the first communication apparatus 2 controls the retransmission of the first and second packets based on at least one of the decoded-data number and the received-data number. Therefore, for example, it is possible to efficiently perform the retransmission of packets by canceling the retransmission of successfully decoded data and/or successfully received data.

### Second Example Embodiment

A second example embodiment, which is an example of an example embodiment of the present disclosure, will be described in detail with reference to the drawings. Components having the same functions as those of components described in the above-described example embodiment are assigned the same reference numerals (or symbols), and their descriptions will be omitted as appropriate. Note that the scope of the application of each technical means employed in this example embodiment is not limited to that in this example embodiment. That is, each technical means employed in this example embodiment can also be employed in other example embodiments included in the present disclosure to the extent that no particular technical difficulty occurs. Further, each technical means employed in each of the drawings which are referred to in order to describe this example embodiment can also be employed in other example embodiments included in the present disclosure to the extent that no particular technical difficulty occurs.

### Configuration of Communication Apparatus 1A

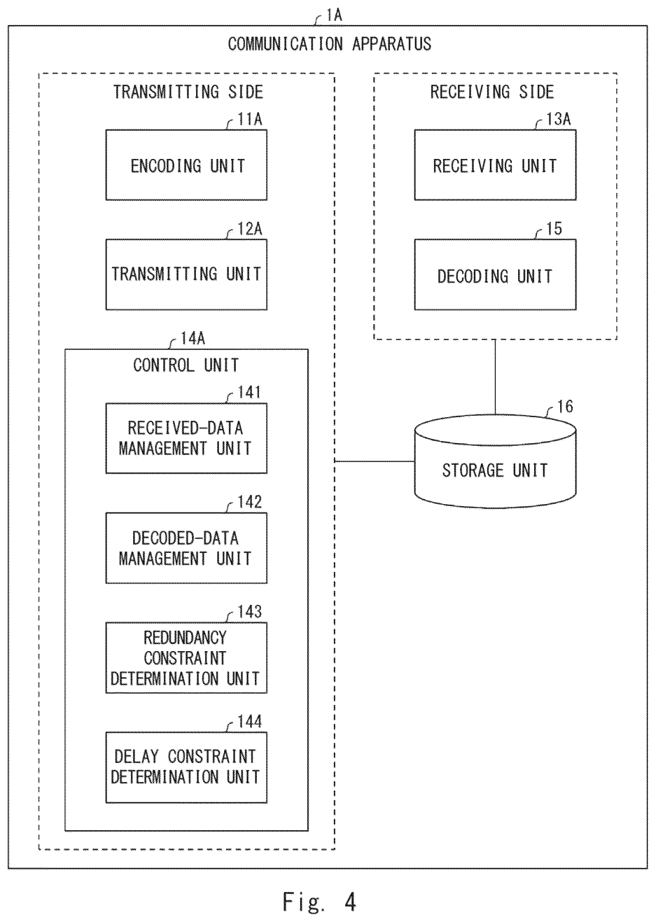

A configuration of a communication apparatus 1A will be described with reference to FIG. 4. FIG. 4 is a block diagram showing the configuration of the communication apparatus 1A. Note that although a case where the communication apparatus 1A performs optical free space communication will be described, it may be, for example, an apparatus that uses radio waves. The communication apparatus 1A includes an encoding unit 11A, a transmitting unit 12A, a receiving unit 13A, a control unit 14A, a decoding unit 15, and a storage unit 16. Note that it is assumed that the communication apparatus on the other side also has the same configuration as that of the communication apparatus 1A, and it is referred to as a communication apparatus 1B in the following description.

Further, the control unit 14A includes a received-data management unit 141, a decoded-data management unit 142, a redundancy constraint determination unit 143, and a delay constraint determination unit 144.

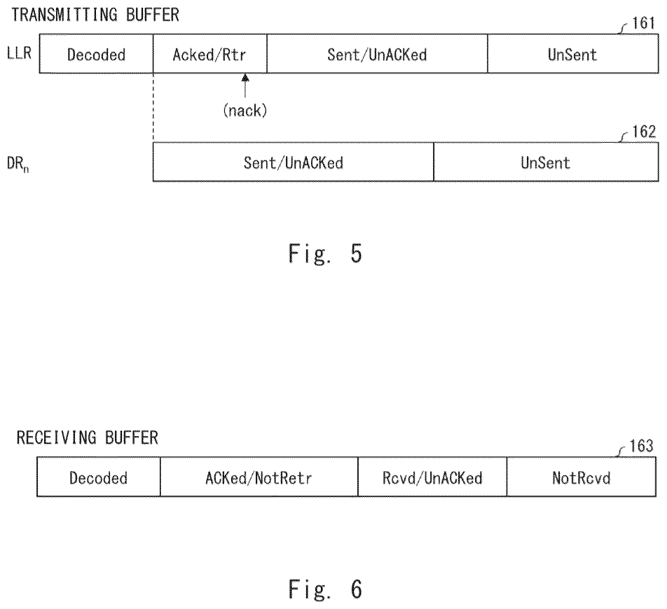

Firstly, a transmitting buffer and a receiving buffer disposed in the storage unit 16 will be described. FIG. 5 is a diagram for explaining the transmitting buffer. The transmitting buffer includes an LLR (Low-Latency Redundancy) buffer 161 for transmitting a low-latency code block and a DRn (Delayed Redundancy) buffer 162 for transmitting a delayed redundancy block. The delayed redundancy block refers to, in the case where a low-latency code block is transmitted and then the same data is redundantly transmitted again, this data group.

The LLR buffer 161 includes a Decoded area, an Acked/Rtr area, a Sent/UnACked area, and an UnSent area. The Decoded area is an area for storing data of which the completion of the decoding has already been reported. The Acked/Rtr area is an area for storing data of which an acknowledgement (ACK) or a negative acknowledgement (NACK) has already been notified.

The Sent/UnACKed area is an area for storing data which has already been transmitted, but of which neither an ACK nor a NACK has been notified. The Unsent area is an area for storing data which is scheduled to be transmitted, but has not yet been transmitted.

The DRn buffer 162 is a buffer for storing data which is scheduled to be redundantly transmitted (delayed redundancy block), and includes a Sent/UnACKed area and an Unsent area. The Sent/UnACKed area is an area for storing data which has already been transmitted, but of which neither an ACK nor a NACK has been notified. The Unsent area is an area for storing data which is scheduled to be transmitted, but has not yet been transmitted. Note that the DRn buffer 162 is also referred to as a transmission list.

FIG. 6 is a diagram for explaining the receiving buffer. The receiving buffer 163 includes a Decoded area, an Acked/NotRtr area, an Rcvd/UnACked area, and a NotRcvd area. The Decoded area is an area for storing data of which the decoding has already been completed. The Acked/NotRtr area is an area for storing data of which an acknowledgement (ACK) or a negative acknowledgement (NACK) has already been notified.

The Rcvd/UnACked area is an area for storing data which has already been received, but of which neither an ACK nor a NACK has been notified. The NotRcvd area is an area for storing data which is scheduled to be received, but has not yet been received.

The encoding unit 11A generates encoded data encoded by using at least two data among a plurality of data. For example, in a case where data D0 to D3 are transmitted to the communication apparatus on the other side, the encoding unit 11A generates encoded data by calculating exclusive OR between the data D0 and D1.

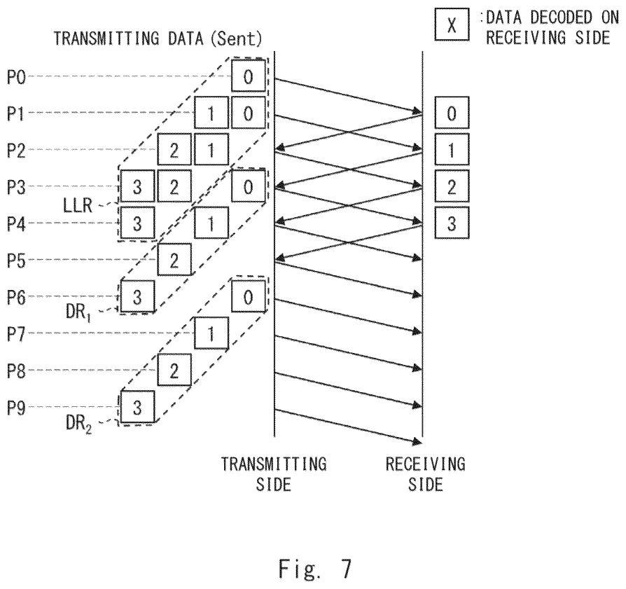

The transmitting unit 12A redundantly transmits a first packet including at least one of a plurality of data and a second packet including encoded data to the communication apparatus on the other side. FIG. 7 shows an example of an encoding method performed by the communication apparatus 1A according to this example embodiment. A case where the communication apparatus 1A transmits data “0” to “3” to the communication apparatus on the other side will be described.

Firstly, the transmitting unit 12A transmits a packet P0 including data “0” and then transmits a packet P1 including encoded data obtained by calculating exclusive OR between data “0” and “1”. After that, the transmitting unit 12A transmits a packet P2 including encoded data obtained by calculating exclusive OR between data “1” and “2”.

After that, the transmitting unit 12A transmits a packet P3 including encoded data obtained by calculating exclusive OR among data “0”, “2” and “3”. After that, the transmitting unit 12A transmits a packet P4 including encoded data obtained by calculating exclusive OR between data “1” and “3”.

Among the data included in the packets P0 to P4, the data enclosed by dotted lines correspond to a low-latency code block and are stored in one of the areas of the above-described LLR buffer 161 according to the state at that time.

The data “0” of the packet P3, the data “1” of the packet P4, the data “2” of the packet P5, and the data “3” of the packet P6 correspond to the first delayed redundancy block and are stored in one of the areas of the above-described DR1 buffer 162 according to the state at that time.

Further, the data “0” of the packet P6, the data “1” of the packet P7, the data “2” of the packet P8, and the data “3” of the packet P9 correspond to the second delayed redundancy block and are stored in one of the areas of the above-described DR2 buffer 162 according to the state at that time.

The receiving unit 13A of the communication apparatus 1B on the other side receives the first and second packets from the communication apparatus 1A. Then, the decoding unit 15 of the communication apparatus 1B on the other side decodes data by using the first and second packets.

In FIG. 7, in a case where the receiving unit 13A of the communication apparatus 1B on the other side has successfully received the packet P0, the transmitting unit 12A of the communication apparatus 1B on the other side returns an acknowledgement (ACK) for the packet P0 to the communication apparatus 1A. Further, in a case where the receiving unit 13A of the communication apparatus 1B on the other side has successfully received the packet P1 and the decoding unit 15 of the communication apparatus 1B on the other side decodes the data “1”, the transmitting unit 12A of the communication apparatus 1B on the other side returns an acknowledgement (ACK) for the packet P1 to the communication apparatus 1A. This acknowledgement includes a decoded-data number and a received-data number. After that, similar processes are performed.

### Specific Example of Case Where Redundant Transmission is Canceled

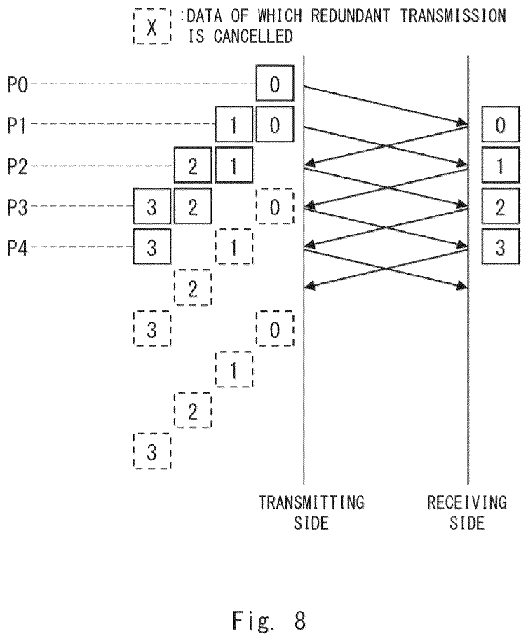

FIG. 8 is a diagram for explaining a specific example of a case where redundant transmission is canceled. Firstly, the communication apparatus 1A transmits a packet P0 including data “0” to the communication apparatus 1B on the other side. The communication apparatus 1B on the other side receives the packet P0 and transmits an acknowledgement including a decoded-data number corresponding to the data “0” and a received-data number to the communication apparatus 1A.

Further, the communication apparatus 1A transmits a packet P1 including encoded data of data “0” and “1” to the communication apparatus 1B on the other side. The communication apparatus 1B on the other side receives the packet P1 and decodes the data “1”. Then, the communication apparatus 1B on the other side transmits an acknowledgement including a decoded-data number corresponding to the data “1” and a received-data number to the communication apparatus 1A.

The control unit 14A of the communication apparatus 1A generates a transmission list of data that the control unit 14A intends to retransmit, deletes, from the transmission list, data corresponding to the decoded-data number included in the acknowledgement received from the communication apparatus 1B on the other side, and controls the retransmission of the first and second packets based on the transmission list from which the data corresponding to the decoded-data number has been deleted.

Specifically, in a case where the receiving unit 13A of the communication apparatus 1A receives an acknowledgement corresponding to the data “0”, the decoded-data management unit 142 of the communication apparatus 1A refers to the DRn buffer 162 and deletes the data “0” from the delayed redundancy packet scheduled to be transmitted. As shown in FIG. 8, since the data “0” scheduled to be transmitted is deleted from the packet P3, the transmitting unit 12A of the communication apparatus 1A transmits the packet P3 including the encoded data of the data “2” and “3” to the communication apparatus 1B on the other side.

Similarly, in a case where the receiving unit 13A of the communication apparatus 1A receives an acknowledgement corresponding to the data “1”, the decoded-data management unit 142 of the communication apparatus 1A refers to the DRn buffer 162 and deletes the data “1” from the delayed redundancy packet scheduled to be transmitted. As shown in FIG. 8, since the data “1” scheduled to be transmitted is deleted from the packet P4, the transmitting unit 12A of the communication apparatus 1A transmits the packet P4 including the data “3” to the communication apparatus 1B on the other side. After that, similar processes are performed.

### Specific Example of Retransmission in Case Where There is Redundancy Constraint

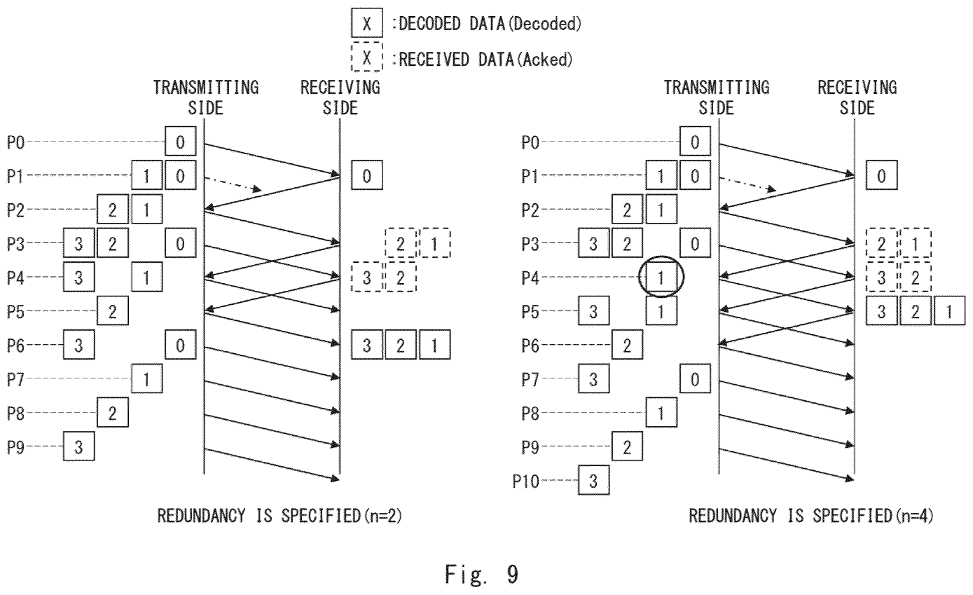

FIG. 9 is a diagram for explaining redundant transmission in a case where there is a redundancy constraint. A redundancy constraint is to impose a limit on the number of times of scheduled redundancy transmission of data. For example, in a case where the specified redundancy n is two (n=2), the number of times of scheduled redundancy transmission of data is limited to two.

The receiving unit 13A of the communication apparatus 1A receives, from the communication apparatus 1B on the other side, an acknowledgement including a request to retransmit a missing packet caused by a failure in the reception of a packet. Then, the control unit 14A of the communication apparatus 1A generates a transmission list of data that the control unit 14A intends to retransmit, and controls the retransmission of the data corresponding to the missing packet in a case where the number of times of scheduled retransmission of the data corresponding to the retransmission-requested packet included in the transmission list is smaller than a predetermined number.

Specifically, in a case where there is a request to retransmit data from the communication apparatus 1B on the other side, the redundancy constraint determination unit 143 refers to the DRn buffer 162 and counts the number of times of scheduled redundancy transmission of the data. Then, in a case where the counted number of times is smaller than the specified redundancy n, the transmitting unit 12A retransmits the packet including the data.

The left part of FIG. 9 shows redundant transmission in a case where the specified redundancy n is two (n=2), and it is assumed that the communication apparatus 1A has transmitted a packet P1 including encoded data of data “0” and “1”, and the communication apparatus 1B on the other side has failed to receive the packet P1, so that the packet P1 is missing. In this case, the transmitting unit 12A of the communication apparatus 1B on the other side transmits an acknowledgement including a retransmission request (NACK) for the packet P1 to the communication apparatus 1A.

In a case where the communication apparatus 1A receives the acknowledgement including the retransmission request (NACK) from the communication apparatus 1B on the other side, the redundancy constraint determination unit 143 of the communication apparatus 1A refers to the DRn buffer 162 and counts the number of times of scheduled redundant transmission of the data “1”. As shown in the left part of FIG. 9, since the number of times of scheduled redundant transmission of the data “1” is “2” and is equal to or larger than the specified redundancy n, the transmitting unit 12A of the communication apparatus 1A does not retransmit the data “1”.

Further, once the communication apparatus 1A transmits a packet P2 including encoded data of data “1” and “2”, even if communication apparatus 1B receives the packet P2, it cannot decode the data “1” and “2”, so that it transmits an acknowledgement including the data “1” and “2” to the communication apparatus 1A as a received-data number.

Further, once the communication apparatus 1A transmits a packet P3 including encoded data of data “0 ”, “2” and “3”, even if the communication apparatus 1B receives the packet P3, it cannot decode the data “2” and “3”, so that it transmits an acknowledgement including the data “2” and “3” to the communication apparatus 1A as a received-data number.

As described above, since the communication apparatus 1A receives an acknowledgement including a received-data number from the communication apparatus 1B on the other side, the received-data management unit 141 of the communication apparatus 1A can manage data (received data) that has not been able to be decoded in the communication apparatus 1B on the other side. The communication apparatus 1A may determine data to be retransmitted by referring to the received-data number included in the acknowledgement received from the communication apparatus 1B on the other side.

The right part of FIG. 9 shows redundant transmission in a case where the specified redundancy n is four (n=4), and it is assumed that the communication apparatus 1A has transmitted a packet P1 including encoded data of data “0” and “1”, and the communication apparatus 1B on the other side has failed to receive the packet P1, so that the packet P1 is missing. In this case, the transmitting unit 12A of the communication apparatus 1B on the other side transmits an acknowledgement including a retransmission request (NACK) for the packet P1 to the communication apparatus 1A.

In a case where the communication apparatus 1A receives the acknowledgement including the retransmission request (NACK) from the communication apparatus 1B on the other side, the redundancy constraint determination unit 143 of the communication apparatus 1A refers to the DRn buffer 162 and counts the number of times of scheduled redundant transmission of the data “1”. As shown in the right part of FIG. 9, since the number of times of scheduled redundant transmission of the data “1” is “2” and is smaller than the specified redundancy n, the transmitting unit 12A of the communication apparatus 1A retransmits the data “1” (packet P4).

In a case where the receiving unit 13A of the communication apparatus 1B on the other side receives the data “1” (packet P4), the decoding unit 15 of the communication apparatus 1B on the other side can decode the data “1”, “2” and “3”. The transmitting unit 12A of the communication apparatus 1B on the other side transmits an acknowledgement including the data “1”, “2” and “3” to the communication apparatus 1A as a decoded-data number.

### Specific Example of Retransmission in Case Where There is Delay Constraint

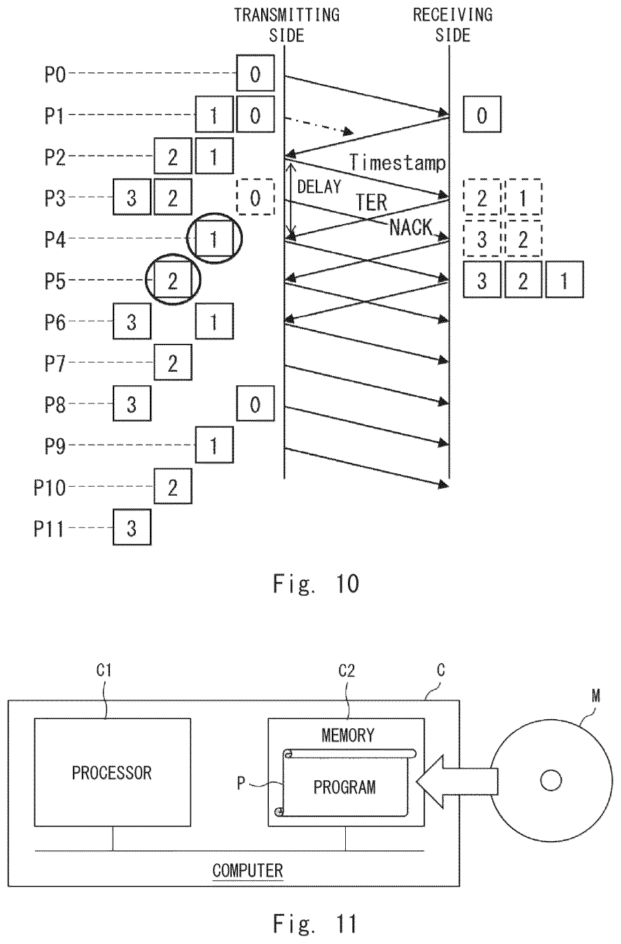

FIG. 10 is a diagram for explaining redundant transmission in a case where there is a delay constraint. The delay constraint means that redundant transmission is performed in a case where a measured delay time is within a predetermined delay constraint specifying range, and redundant transmission is not performed in a case where the delay time is outside the predetermined delay constraint specifying range.

The receiving unit 13A of the communication apparatus 1A receives, from the communication apparatus 1B on the other side, an acknowledgement including a request to retransmit a missing packet caused by a failure in the reception of a packet. Then, the control unit 14A of the communication apparatus 1A refers to a delay time included in the acknowledgement and, in a case where the delay time satisfies the predetermined delay constraint, retransmits the data corresponding to the missing packet.

As shown in FIG. 10, it is assumed that the communication apparatus 1A transmits a packet P1 including encoded data of data “0” and “1”, and the communication apparatus 1B on the other side has failed to receive the packet P1, so that the packet P1 is missing.

The transmitting unit 12A of the communication apparatus 1A stores a Timestamp t in a packet P2 and transmits it to the communication apparatus 1B on the other side. In a case where the receiving unit 13A of the communication apparatus 1B on the other side receives the packet P2, the transmitting unit 12A of the communication apparatus 1B on the other side returns an acknowledgement (ACK) and a Timestamp echo reply t (TER). Note that since the packet P1 is missing, the receiving unit 13A transmits an acknowledgement including a retransmission request (NACK) for the packet P1 to the communication apparatus 1A. Note that since the data “0” has already been decoded, it is assumed that the receiving unit 13A requests the retransmission of the data “1” and “2”.

In a case where a difference between the Timestamp echo reply t and the current time is within the delay constraint specifying range, the delay constraint determination unit 144 of the communication apparatus 1A retransmits a packet P4 including data “1” to the communication apparatus 1B on the other side. Then, the delay constraint determination unit 144 of the communication apparatus 1A retransmits a packet P5 including data “2” to the communication apparatus 1B on the other side.

### Effect of Communication Apparatus 1A

As described above, in the communication apparatus 1A, the control unit 14A deletes, from the transmission list, data corresponding to a decoded-data number included in an acknowledgement received from the communication apparatus 1B on the other side. Therefore, it is possible to prevent already-decoded data from being retransmitted, and thereby to efficiently perform the retransmission of packets.

Further, in the communication apparatus 1A, in a case where the number of times of scheduled retransmission of data corresponding to a retransmission- requested packet included in the transmission list is smaller than a predetermined number, the control unit 14A controls the retransmission of the data corresponding to the missing packet. Therefore, it is possible to prevent retransmission from being performed a predetermined number of times or more, and thereby to efficiently perform the retransmission of packets.

Further, in the communication apparatus 1A, the control unit 14A refers to a delay time included in an acknowledgement and, in a case where the delay time satisfies a predetermined delay constraint, retransmits the data corresponding to the missing packet. Therefore, it is possible to prevent data that does not satisfy the delay constraint from being retransmitted, and thereby to efficiently perform the retransmission of packets.

### Example of Implementation by Software

Some or all of the functions of the communication apparatuses 1 or 1A may be implemented by hardware such as an integrated circuit (IC chip) or by software.

In the latter case, each of the above-described communication apparatuses 1 and 1A may be implemented by, for example, a computer that executes instructions of a program which is software for implementing each function. FIG. 11 shows an example of such a computer (hereinafter referred to as a computer C). FIG. 11 is a block diagram showing a hardware configuration of the computer C functioning as each of the above-described communication apparatuses 1 and 1A.

The computer C includes at least one processor C1 and at least one memory C2. A program P for operating the computer C as each of the above-described systems is recorded in the memory C2. In the computer C, the processor C1 loads the program P from the memory C2 and executes the loaded program, so that the functions of the above-described communication apparatuses 1 and 1A are implemented.

The processor C1 may be, for example, a CPU (Central Processing Unit), a GPU (Graphic Processing Unit), a DSP (Digital Signal Processor), an MPU (Micro Processing Unit), an FPU (Floating Point Number Processing Unit), a PPU (Physics Processing Unit), a TPU (Tensor Processing Unit), a quantum processor, a microcontroller, or a combination thereof. The memory C2 may be, for example, a flash memory, an HDD (Hard Disk Drive), an SSD (Solid State Drive), or a combination thereof.

Note that the computer C may further include a RAM (Random Access Memory) for unfolding the program P when it is executed, and for temporarily storing various data. Further, the computer C may further include a communication interface for transmitting/receiving data to/from other apparatuses. Further, the computer C may further include an input/output interface for connecting input/output devices such as a keyboard, a mouse, a display device, and a printer.

Further, the program P can be recorded on a non-transitory tangible recording medium M that the computer C can read. As such a recording medium M, for example, a tape, a disk, a card, a semiconductor memory, or a programmable logic circuit can be used. The computer C can acquire the program P through such a recording medium M. Further, the program P can be transmitted through a transmission medium. As such a transmission medium, for example, a communication network or a broadcast wave can be used. The computer C can also acquire the program P through such a transmission medium.

While the present disclosure has been particularly shown and described with reference to example embodiments thereof, the present disclosure is not limited to these example embodiments. It will be understood by those of ordinary skill in the art that various changes in form and details may be made therein without departing from the sprit and scope of the present disclosure as defined by the claims. And each example embodiment can be appropriately combined with at least one of example embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Further, the scope of the claims is not limited by the embodiments described above.

Furthermore, it is noted that, Applicant's intent is to encompass equivalents of all claim elements, even if amended later during prosecution.

### Supplementary Matter 1

The present disclosure includes technologies described in supplementary notes described below. However, the present disclosure is not limited to the technologies described in the supplementary notes described below, and various modifications can be made with the scope specified in the claims.

### Supplementary Note 1

A communication apparatus comprising:
encoding means for generating encoded data encoded by using at least two data among a plurality of data;
transmitting means for redundantly transmitting a first packet including at least one of the plurality of data and a second packet including the encoded data to a communication apparatus on the other side;
receiving means for receiving, from the communication apparatus on the other side, an acknowledgement including at least one of a decoded-data number corresponding to data successfully decoded by using the first and second packets, and a received-data number corresponding to data included in the successfully received first and second packets; and
control means for controlling retransmission of the first and second packets based on at least one of the decoded-data number and the received-data number.

### Supplementary Note 2

The communication apparatus described in Supplementary note 1, wherein the control means:
generates a transmission list of data that the control means intends to retransmit;
deletes, from the transmission list, data corresponding to the decoded-data number included in the acknowledgement received from the communication apparatus on the other side; and
controls retransmission of the first and second packets based on the transmission list from which the data corresponding to the decoded-data number has been deleted.

### Supplementary Note 3

The communication apparatus described in Supplementary note 1 or 2, wherein
the receiving means receives, from the communication apparatus on the other side, the acknowledgement including a request to retransmit a missing packet caused by a failure in a reception of a packet, and
the control means:
generates a transmission list of data that the control means intends to retransmit; and
controls retransmission of data corresponding to the missing packet in a case where the number of times of scheduled retransmission of data corresponding to the retransmission-requested packet included in the transmission list is smaller than a predetermined number.

### Supplementary Note 4

The communication apparatus described in any one of Supplementary notes 1 to 3, wherein
the receiving means receives, from the communication apparatus on the other side, the acknowledgement including a request to retransmit a missing packet caused by a failure in a reception of a packet, and
the control means refers to a delay time included in the acknowledgement and, in a case where the delay time satisfies a predetermined delay constraint, retransmits data corresponding to the missing packet.

### Supplementary Note 5

The communication apparatus described in any one of Supplementary notes 1 to 4, wherein
the transmitting means redundantly transmits the first and second packets to the communication apparatus on the other side through optical free space communication, and
the receiving means receives the acknowledgement through the optical free space communication.

### Supplementary Note 6

A communication method comprising:
generating encoded data encoded by using at least two data among a plurality of data;
redundantly transmitting a first packet including at least one of the plurality of data and a second packet including the encoded data to a communication apparatus on the other side;
receiving, from the communication apparatus on the other side, an acknowledgement including at least one of a decoded-data number corresponding to data successfully decoded by using the first and second packets, and a received-data number corresponding to data included in the successfully received first and second packets; and
controlling retransmission of the first and second packets based on at least one of the decoded-data number and the received-data number.

### Supplementary Note 7

The communication method described in Supplementary note 6, wherein in the controlling of the retransmission,
a transmission list of data scheduled to be retransmitted is generated,
data corresponding to the decoded-data number included in the acknowledgement received from the communication apparatus on the other side is deleted from the transmission list, and
the retransmission of the first and second packets is controlled based on the transmission list from which the data corresponding to the decoded-data number has been deleted.

### Supplementary Note 8

The communication method described in Supplementary note 6 or 7, wherein
in the receiving of the acknowledgement, the acknowledgement including a request to retransmit a missing packet caused by a failure in a reception of a packet is received from the communication apparatus on the other side, and
in the controlling of the retransmission,
a transmission list of data scheduled to be retransmitted is generated, and
the retransmission of data corresponding to the missing packet is controlled in a case where the number of times of scheduled retransmission of data corresponding to the retransmission-requested packet included in the transmission list is smaller than a predetermined number.

### Supplementary Note 9

The communication method described in any one of Supplementary notes 6 to 8, wherein
in the receiving of the acknowledgement, the acknowledgement including a request to retransmit a missing packet caused by a failure in a reception of a packet is received from the communication apparatus on the other side, and
in the controlling of the retransmission, a delay time included in the acknowledgement is referred to, and in a case where the delay time satisfies a predetermined delay constraint, data corresponding to the missing packet is retransmitted.

### Supplementary Note 10

A communication system comprising a first communication apparatus and a second communication apparatus, wherein
the first communication apparatus includes:
encoding means for generating encoded data encoded by using at least two data among a plurality of data;
first transmitting means for redundantly transmitting a first packet including at least one of the plurality of data and a second packet including the encoded data to the second communication apparatus; and
first receiving means for receiving an acknowledgement from the second communication apparatus,
the second communication apparatus includes:
second receiving means for receiving the first and second packets from the first communication apparatus;
decoding means for decoding data by using the first and second packets; and
second transmitting means for transmitting, to the first communication apparatus, the acknowledgement including at least one of a decoded-data number corresponding to data successfully decoded by using the first and second packets, and a received-data number corresponding to data included in the successfully received first and second packets, and
the first communication apparatus further comprises control means for controlling retransmission of the first and second packets based on at least one of the decoded-data number and the received-data number included in the acknowledgement received by the first receiving means.

### Supplementary Note 11

A control program for operating a computer as a communication apparatus described in any of Supplementary notes 1 to 5, wherein the control program makes the computer function as each of the means.

What is claimed is:

1. A communication apparatus comprising:
at least one memory storing instructions, and
at least one processor configured to execute the instructions to:
generate encoded data encoded by using at least two data among a plurality of data;
redundantly transmit a first packet including at least one of the plurality of data and a second packet including the encoded data to a communication apparatus on the other side;
receive, from the communication apparatus on the other side, an acknowledgement including at least one of a decoded-data number corresponding to data successfully decoded by using the first and second packets, and a received-data number corresponding to data included in the successfully received first and second packets; and
control retransmission of the first and second packets based on at least one of the decoded-data number and the received-data number.

2. The communication apparatus according to claim 1, wherein the at least one processor is configured to execute the instructions to:
generate a transmission list of data scheduled for retransmission;
delete, from the transmission list, data corresponding to the decoded-data number included in the acknowledgement received from the communication apparatus on the other side; and
control retransmission of the first and second packets based on the transmission list from which the data corresponding to the decoded-data number has been deleted.

3. The communication apparatus according to claim 1, wherein the at least one processor is configured to execute the instructions to:
receive, from the communication apparatus on the other side, the acknowledgement including a request to retransmit a missing packet caused by a failure in a reception of a packet, and
generate a transmission list of data scheduled for retransmission; and
control retransmission of data corresponding to the missing packet in a case where scheduled retransmission of data corresponding to the packet of the request to retransmit is not included in the transmission list a predetermined number of times or more.

4. The communication apparatus according to claim 1, wherein the at least one processor is configured to execute the instructions to:
receive, from the communication apparatus on the other side, the acknowledgement including a request to retransmit a missing packet caused by a failure in a reception of a packet, and
refer to a delay time included in the acknowledgement and, in a case where the delay time satisfies a predetermined delay constraint, retransmit data corresponding to the missing packet.

5. The communication apparatus according to claim 1, wherein the at least one processor is configured to execute the instructions to:
redundantly transmit the first and second packets to the communication apparatus on the other side through optical free space communication, and
receive the acknowledgement through the optical free space communication.

6. A communication method comprising:
generating encoded data encoded by using at least two data among a plurality of data;
redundantly transmitting a first packet including at least one of the plurality of data and a second packet including the encoded data to a communication apparatus on the other side;
receiving, from the communication apparatus on the other side, an acknowledgement including at least one of a decoded-data number corresponding to data successfully decoded by using the first and second packets, and a received-data number corresponding to data included in the successfully received first and second packets; and
controlling retransmission of the first and second packets based on at least one of the decoded-data number and the received-data number.

7. The communication method according to claim 6, wherein the controlling of the retransmission comprises:
generating a transmission list of data scheduled for retransmission;
deleting, from the transmission list, data corresponding to the decoded-data number included in the acknowledgement received from the communication apparatus on the other side; and
controlling the retransmission of the first and second packets based on the transmission list from which the data corresponding to the decoded-data number has been deleted.

8. The communication method according to claim 6, wherein
the receiving of the acknowledgement comprises receiving, from the communication apparatus on the other side, the acknowledgement including a request to retransmit a missing packet caused by a failure in a reception of a packet, and
the controlling of the retransmission comprises:
generating a transmission list of data scheduled for retransmission; and
controlling the retransmission of data corresponding to the missing packet in a case where scheduled retransmission of data corresponding the packet of the request to retransmit is not included in the transmission list a predetermined number of times or more.

9. The communication method according to claim 6, wherein
the receiving of the acknowledgement comprises receiving, from the communication apparatus on the other side, the acknowledgement including a request to retransmit a missing packet caused by a failure in a reception of a packet, and
the controlling of the retransmission comprises referring to a delay time included in the acknowledgement, and in a case where the delay time satisfies a predetermined delay constraint, retransmitting data corresponding to the missing packet.

10. A communication system comprising a first communication apparatus and a second communication apparatus, wherein
the first communication apparatus comprises:
at least one first memory storing instructions, and
at least one first processor configured to execute the instructions to:
generate encoded data encoded by using at least two data among a plurality of data;
redundantly transmit a first packet including at least one of the plurality of data and a second packet including the encoded data to the second communication apparatus; and
receive an acknowledgement from the second communication apparatus,
the second communication apparatus comprises:
at least one second memory storing instructions, and
at least one second processor configured to execute the instructions to:
receive the first and second packets from the first communication apparatus;
decode data by using the first and second packets; and
transmit, to the first communication apparatus, the acknowledgement including at least one of a decoded-data number corresponding to data successfully decoded by using the first and second packets, and a received-data number corresponding to data included in the successfully received first and second packets, and
the at least one first processor is further configured to execute the instructions to control retransmission of the first and second packets based on at least one of the decoded-data number and the received-data number included in the received acknowledgement.
